(19) United States
(12) Patent Application Publication
(10) Pub. No.: US 2008/0154899 A1
(43) Pub. Date: Jun. 26, 2008

(54) System and method for anonymous dating compatibility determination

(76) Inventor: Kevin B. Carmony, Rancho Santa Fe, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/004,921

(22) Filed: Dec. 21, 2007

Related U.S. Application Data
(63) Continuation-in-part of application No. 11/710,459, filed on Feb. 22, 2007.
(60) Provisional application No. 60/876,676, filed on Dec. 23, 2006.

(51) Int. Cl. G06F 17/30

(52) U.S. Cl. 707/6; 707/E17.014

(57) ABSTRACT

A system and method for human compatibility matching allowing individuals to remain anonymous unless a compatibility score threshold is met or exceeded. Compatibility between individuals is determined using a computer network based system which allows for an anonymous identification for users to a third party or fellow user and a subsequent comparison for compatibility of the two parties as potential daters. Contact information is only revealed to the parties if predetermined compatibility thresholds are met or exceeded as set by one or both individuals. The system also provides for inclusion of an Application Program Interface in websites of subscribers to provide compatibility matching of visitors to the website with the owner or individual featured on the website.

### FIELD OF THE INVENTION

This application is a Continuation in Part of U.S. patent application Ser. No. 11/710,459, filed Feb. 22, 2007 and incorporated herein in its entirety by reference and which claims the benefit of U.S. Provisional Patent application No. 60/876,676 filed Dec. 23, 2006. The disclosed system and method relate generally to a system for human compatibility matching. More particularly, it relates to a system for determining dating compatibility for a network-based dating system for subscribers which allows for an anonymous identification of a subscriber or user to a third party or fellow subscriber or user, and a comparison for compatibility of potential daters prior to initiating identity revealing communication between the two individuals.

### BACKGROUND OF THE INVENTION

Dating services that are offered online throughout the world have proliferated in the last few years due to the rise and acceptance of the internet. What once was the province of “dating services” who interviewed and matched potential partners personally is now handled over the internet in varying tangents on the theme of matching men and women seeking companionship and romance with other men and women seeking the same.

While initially such subscriber systems simply matched user provided information and photos with inquiring suitors and let the parties ascertain compatibly, today a number of website-based services take it a step further. Such services conventionally administer a personality test to subscribers consisting of many questions to which the subscriber's answers reveal components of their personality based on norms for the testing administered. Using the test results, subscribers can be “matched” to other subscribers who have taken the test, based on compatibility factors between the two subscribers revealed by the test.

While this is a step above the old services where name and photos were simply exchanged or potential dates searched by geographic location, even compatibility matching has an inherent problem when people meet in person. As has been the case for hundreds of years, men and women seeking the companionship and affection from other men and women tend to visit venues frequented by single or available individuals.

Such personal individual encounters are an excellent way to determine a physical attraction between the parties involved. However, there comes a point in time where the potential dating couple must exchange personal information for subsequent contact. Phone numbers and email addresses are a frequent means to exchange contact information. However, even though there may be sufficient physical attraction to warrant a number exchange, the two parties in question have no idea if they are personally compatible with each other, or, for that matter, if one of the parties is dangerous, or a serial dater, or if some other undesirable or conflicting personality or personal trait has doomed the romance from the start.

However, since the two parties have met in person, it is an awkward situation for one party not to provide the other with subsequent contact information when asked. This is especially a dilemma for women who are frequently smaller in stature then men and at risk from undesirable suitors who may do them harm. While she may have a physical attraction to the man asking for her phone number, she knows nothing about him or his personality or anything else.

The same problem occurs in chat rooms online, in chance encounters on airliners, at parties, or anywhere men and women interact and may become physically attracted. Essentially, there is no way to ascertain if the person asking for contact information is a personality match, dangerous, or a total opposite but still nice.

Accordingly, there is an unmet need for a system and method to provide a means for anonymous identification of individuals who have ascertained an attraction in a personal encounter to each other. Such a method should provide an easy to use unique identifier of each party for subsequent contact. Such a method should provide for some type of personality matching before further contact is authorized or initiated since there is no use in matching people who will not get along with each other based on personality test results. Further, such a system should provide total anonymity to both parties unless both parties decide to allow communication to be initiated. This insures that women and men will not be harassed by suitors who are unacceptable mates simply because one of the two parties wishes to pursue the relationship further.

### SUMMARY OF THE INVENTION

The disclosed system and method provides for easy and quick compatibility testing by subscribers to the service. Personality factors of all subscribers are ascertained through the provision of an online multiple choice or other personality test that determines personality factors of the test taker based on their answers to the questions and testing norms and other researched indicators for personality facets based on the test.

Such factors include but are not limited to:

The type of relationship in which they are interested, their age compatibility, their geographic compatibility, individual views, views in regards to children, current living situations, types of preferred physical attraction, ethnic backgrounds, smoking, drinking & drugs, views on romance & intimacy, personal temperament personality traits, sports & exercise, hobbies, interests, education, career, finances, politics and religion.

Once the test is completed, the user is provided with a personal alphabetic or numeric or other personal unique identifier which in the current method is know as Dating DNA ID. The identifier may be a string of numbers, letters, or both, or a personal name or identifier assigned to each individual. This dating DNA ID or personal identifier allows them to subsequently perform quick automated comparisons between themselves and any other Dating DNA user by entering in their own Dating DNA ID unique personal identifier and that of the other individual. Once two IDs are entered, a Compatibility Score is produced within seconds, giving an indication as to the compatibility level between these two individuals (based on the categories mentioned above). This input for comparison need not be done on a computer terminal but could be done by cellphone or other means to allow the software to compare the two identified persons' compatibility. The Compatibility Score can then be used to quickly determine the level of compatibility for friendship, dating, meeting, or marriage between the two individuals. This is effective in an online search of members of the service or for a comparison between individuals with the service who trade information in person of offline from the service.

As noted, since any two individuals who take the same test will always be a determinable Compatibility Score based on the testing norms and research into the questions and answers provided, the user's unique individual personal identifier becomes a valuable tool when meeting strangers personally or online outside the dating service. Using their assigned or chosen unique identifier and that of the other person, any two subscribers to the service can determine their own compatibility level with respect to another member. In cases where only one person has the assigned or chosen unique identifier, the receiving party would be required to take the test and receive their own unique identifier prior to any optional communication.

The subsequent communication is optional because both parties can input criteria which will be employed by the software which runs the service for what they consider an appropriate Compatibility Score match. Both would essentially set the level of compatibility required to make the potential mate desirable enough to allow for subsequent contact and communication. This becomes an important element with the system disclosed herein because in addition to the conventional provision of online searching for potential mates who match the subscribers prescribed Compatibility Score criteria, where the users remain online and anonymous, the system provides for anonymous personal identification between the subscriber and third parties at bars, nightclubs, on airplanes, at parties, in chat rooms, or wherever two people might meet and communicate and determine a physical or mental attraction to the other.

In such situations, where personal or online communication is raising the interest level of the participants, instead of risking identification of themselves or their home location or other personal information, they instead exchange their assigned or chosen unique personal identifier or Dating DNA number as a means for future contact. One or both parties would then have the other's identifier and be able to input it online to attempt future contact.

Thus, a woman in a bar asking for a phone number or email need not worry about being stalked or harassed by an unsuitable suitor. Instead she need only give the asking party her alphanumeric, numeric, alphabetic, or chosen unique identifier which is her Dating DNA ID, and tell the person asking to contact her through the dating service which assigned the identifier.

Subsequently, if the person receiving the Dating DNA ID initiates contact with the person giving them the unique identifier, they would log into the dating service and input the unique chosen or assigned identifier as their requested party for contact.

It is at this point in the system that the parties control whether there will be subsequent contact between them. Both parties will have been required to take the same online personality test. The inquiring party test results will be compared with the test results of the party who provided the identifier. If a sufficient match is ascertained by the software, both parties will be informed and will be given means for additional contact with each other. However, both parties must set a minimum Compatibility Score level to which they will allow the contact to occur and the Compatibility Score between the two parties compared must meet or exceed the level set by both for the subsequent contact to be allowed by the software.

If the Compatibility Score hits or exceeds the Compatibility Threshold, personal profile information is disclosed to both parties and the means are provided for the individuals to be able to actively communicate with each other. If the Compatibility Threshold is not met for one or both individuals, no personal information is shared, nor is either user provided any means with communicating further with the other individual.

As an option, both parties could be informed of the failure to meet the threshold and if both parties agree, the profile information could still be exchanged. This might occur where the two parties were introduced by a mutual friend or at church or where the physical attraction was so strong that they both wish to override the Compatibility Threshold scores set.

An especially convenient optional mode of the system would allow for employment of the individual's cellular telephone as a means for real time communication of identifiers and real time comparison of subscribers for compatibility. Using the cellular text, or keypad input, communication capability of modern cellular phones, users are able to do a compatibility comparison via their cell phone and text messaging or by an audible reply. In this mode of operation of the method, a subscriber spying a potential mate that is attractive and also a user or subscriber, can initiate a real time compatibility test of the two using cell phones. The unique identifiers of both persons would simply be text messaged or otherwise input into a pre-provided receiving point on the network where the two unique identifiers would be processed by software adapted to the task and compared. One or preferably both respective parties would then be given a return text message showing the Dating DNA comparison number for each other. Instantly they know if their Compatibility Scores are mutually acceptable.

An additional mode of operation of the system is provided for subscribers or users to seek out potential matches in a geographic area proximate to them using modern cell phone triangulation or GPS location abilities of the phones themselves. Employing this mode of the method, subscribers would be allowed to input their cellular phone numbers and carriers and a permission for the system to track their position on the earth during time segments. For subscribers seeking this added service, their whereabouts would be known by the computer running the comparison software for the system.

A user seeking a potentially compatible date for the evening would input a prearranged code or signal or other input into the system which would verify their identity and unique identifier. Thereafter, software adapted to the task would ascertain the location of other subscribers to the system based on their geographic location as reported by their cellular telephone which would continually provide their locations over a network. The subscriber seeking the proximate match would have their compatibility compared with those identified by the unique identifiers for each person being so identified by location through their phones. When a user requesting this seek-a-proximate-match service initiates the request, matching subscribers who can be identified for a geographic location sufficiently proximate to the requesting subscriber would be identified to the requesting subscriber. For example, the requesting subscriber could request a text message from the system should a potential match with a Compatibility Score equal to or higher than set by the subscriber is within a certain distance. If this occurs, the requesting user would be notified by text or audible messaging. Thereafter the requesting user can initiate contact with the proximate subscribers identified for compatibility through the cell phones they both carry or in person if the other party is sufficiently local.

In this respect, before explaining at least one embodiment of the device and method herein in detail, it is to be understood that the invention is not limited in its application to the details of construction, and to the arrangement of the components or method steps set forth in the description herein. The invention is thus capable of other embodiments and of being practiced and carried out in various ways and in different orders of execution. Also, it is to be understood that the phraseology and terminology employed herein are for the purpose of description and should not be regarded as limiting.

As such, those skilled in the art will appreciate that the conception upon which the system for personal individual compatibility match for potential daters using a unique anonymous identifier for individual comparison is based may readily be utilized as a basis for the designing of other methods for carrying out the purposes of the present invention. It is important, therefore, that the claims be regarded as including such equivalent construction insofar as they do not depart from the spirit and scope of the present invention.

It is an object of this invention to provide a method of determining individual persons' compatibility with other persons for dating and friendships.

A further object of this invention is the provision of such compatibility matching system which awards a unique personal identifier to all users or subscribers which identifies their profile in the system.

Yet another object of this invention is the provision of such unique but anonymous identifiers for the purposes of an anonymous identification of the holder when they come into contact with others who request personal information.

It is a further object of the invention to provide a means for determining a sufficient match of compatibility between two persons, using computer analysis of files and information relating to their personally chosen or assigned unique identifiers which were exchanged offsite to compare their respective personality profiles for a sufficient match before any personal identification or location information is exchanged between the two.

Yet another object of the invention is to provide a means for a real time determination of a sufficient match of compatibility between two persons, using their respective cellular telephones to request a comparison of their unique identifiers and notification of a compatibility match through their respective phones.

A further object of the invention is to provide a means for determining a sufficient match of compatibility between two persons proximate to each other, using their personally chosen or assigned unique identifiers combined with their geographic locations communicated over cellular telephones.

It is a further object of this invention, to provide subscribers and users with unique identifiers relating to their personality and compatibility scores which may be published by the holder of that identifier on web pages for a search engine or crawler to find and attempt to match them to other subscribers to the system.

These together with other objects and advantages which will become subsequently apparent reside in the details of the construction and method as more fully hereinafter described and claimed, reference being had to the accompanying drawings forming a part thereof, wherein like numerals refer to like parts throughout.

With respect to the above description then, it is to be realized that the optimum relationships for the method and hardware herein are to include variations in function and manner of operation, steps in operation and use, which are readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

### BRIEF DESCRIPTION OF DRAWINGS

FIG. 1 is a graphic depiction of a flow chart for new user sign in and registered user login, showing the flow path for relating a unique user identifier with results from a compatibility survey and subsequent login for user input of respective unique identifiers to seek matches.

FIG. 2 depicts a typical profile page or homepage of a user, showing their assigned or chosen unique identifier and other personal information, along with the match score threshold for the user, and it includes an entry box to request a comparison with another unique identifier.

FIG. 3 depicts a displayed page showing a user a profile of another user which matches pre-set parameters of one or both users. The page may be displayed on any video capable electronic device such as a computer or cellphone.

FIG. 4 depicts a typical page for question administration for the personality compatibility survey used for all comparisons.

FIG. 5 is a web-based embodiment of the system herein.

### DETAILED DESCRIPTION OF PREFERRED EMBODIMENTS

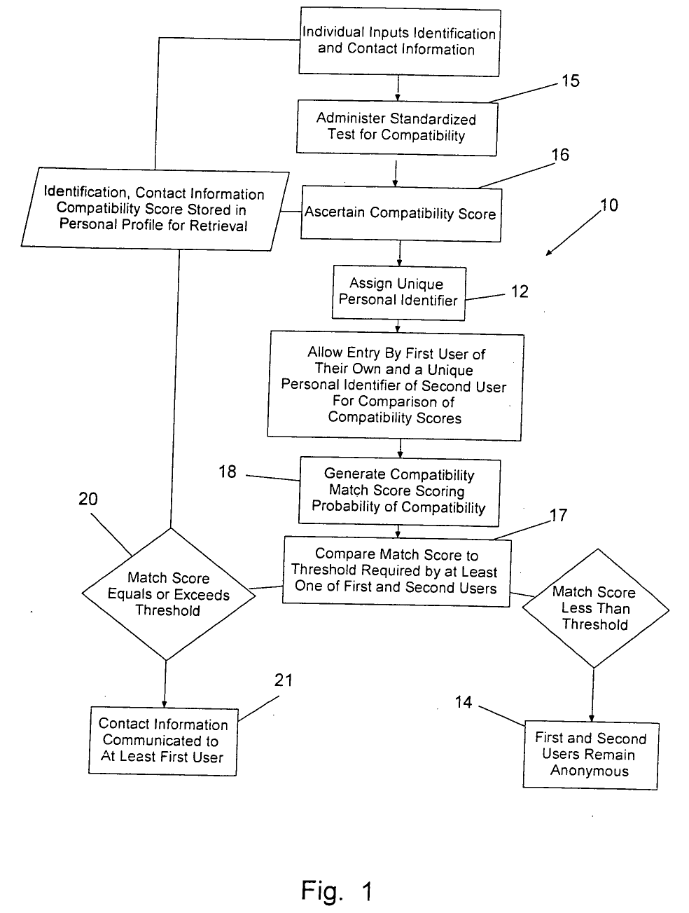

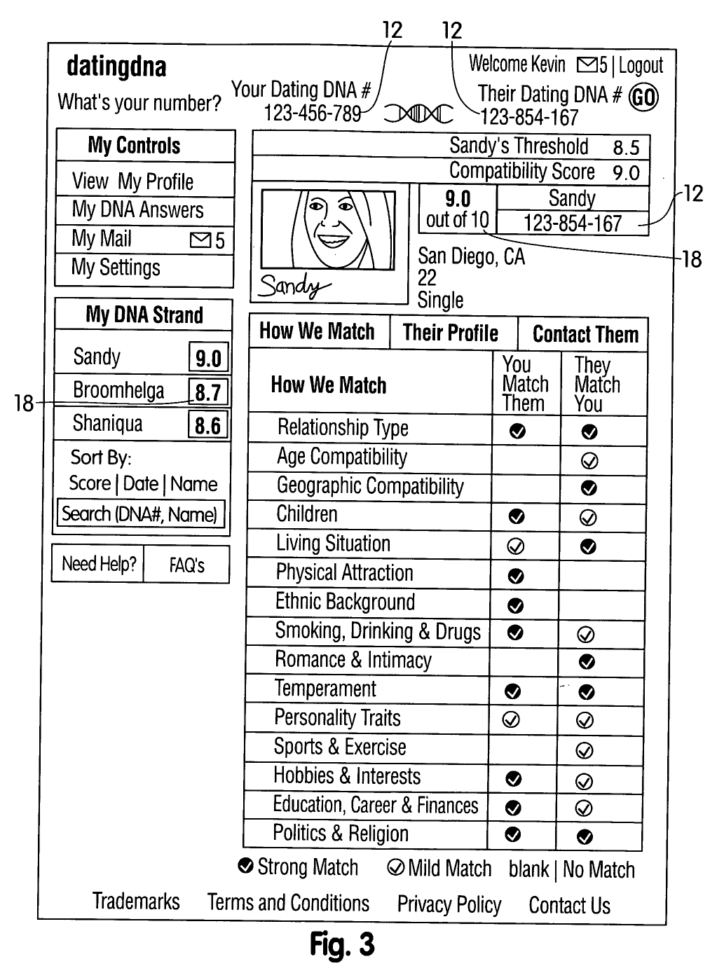

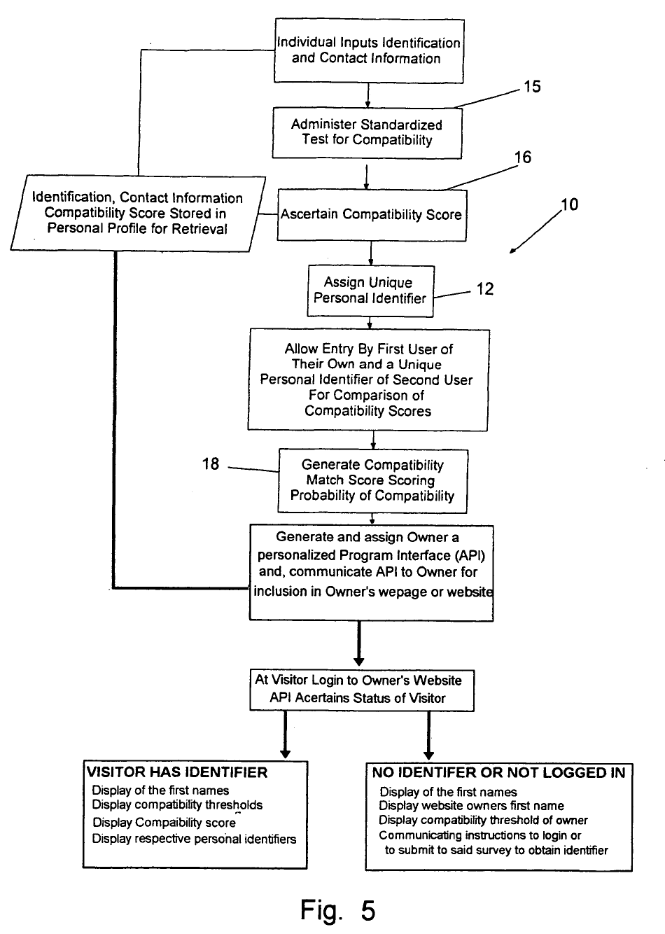

Referring now to the drawings in FIGS. 1-5, some preferred embodiments of the present invention in current preferred modes are shown and described.

In operation, the method and system 10 herein allows client users to obtain a personal identifier 12 which is unique to that individual, and allows them to remain anonymous 14 to other individuals with whom they have a singular or mutual attraction in a personal encounter or a virtual encounter online or by phone or other means of one-on-one communication. They may continue to remain anonymous and unable to be further contacted until each individual's respective compatibility factor is determined by the survey or test 15 and compared with that of the other in a compatibility match scoring 18. The scoring calculating the compatibility match score 18, compares individual responses to the survey or test 15 and will generate a scale or numerical score to designate the degree of matching factors and therefor the potential for compatibility. A threshold compatibility match score 18 is set by at least one user, which must be exceeded for the system to provide contact information to be exchanged whereby one user would be able to make further contact with the other. If set by both parties, only when the threshold that set by both parties is exceeded 20, will the system allow personal contact information to be communicated 21, by providing contact information such as telephone numbers, names, addresses and the likes through a communication to the parties.

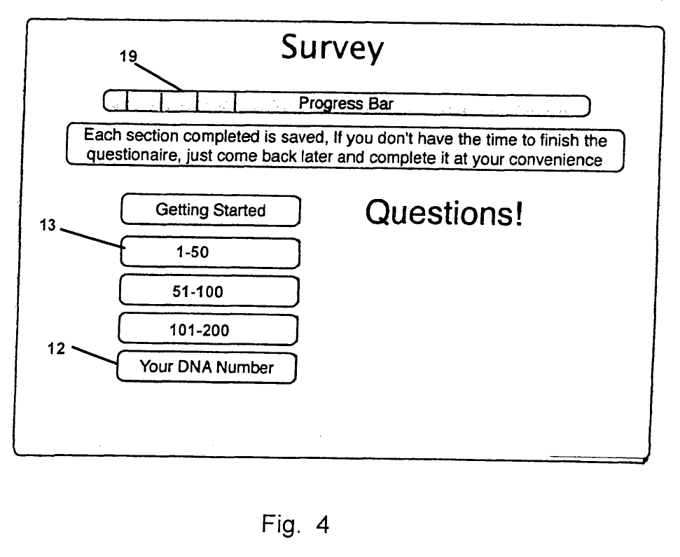

As shown in FIG. 1 each new user or subscriber to the system is required to submit to a compatibility testing 15 by the service providing it. Personality factors of all users or subscribers are ascertained through the provision of an online multiple choice or other personality test in the testing using a survey or test page such as in FIG. 4. The results of the survey or test are determined by their answers to the questions 13 presented which are then compared against testing norms and other researched indicators for their individual specific personality facets based on the test. Questions presented would seek to ascertain their individual personality factors from answers to questions including but not limited to: the type of relationship in which they are interested, their age compatibility with others, their geographic compatibility, individual views, views in regards to children, current living situations, types of preferred physical attraction, ethnic backgrounds, smoking, drinking & drugs, views on romance & intimacy, personal temperament personality traits, sports & exercise, hobbies, interests, education, career, finances, politics and religion.

Once the test is completed, an individual compatibility profile or score 16 for user is ascertained based on the questions 15 answered in the survey. Progress through the survey is provided by a progress visual indicator 19 such as the progress bar on FIG. 4. The user taking and completing the survey is then provided with a unique personal identifier 12 which may be a string of numbers, letters, or both, or a personal name, “handle”, or identifier, which is specific to each individual to which it is assigned and relational to their individual compatibility profile. In the current preferred mode of the method, the unique personal identifier 12 is known as their individual Dating DNA ID.

This personal identifier 12, being unique to the individual to which it is assigned, allows each individual user or subscriber to the system to remain anonymous during any new or subsequent encounter with another individual. No name, address, phone, email, or other information need be provided by one user to the other. The user need only provide the other individual seeking contact information with their personal identifier 12, thereby withholding risky disclosure of their name, address, phone, and other sensitive personal information.

In a typical encounter, a user with a personal identifier 12 may easily perform quick automated comparisons 18 between themselves and any other individual with a personal identifier 12. This is accomplished by inputting their own personal identifier into a means for communication of the personal identifier to a computer hosting software adapted to the task of the input of identifiers and comparing them to other individual unique identifiers.

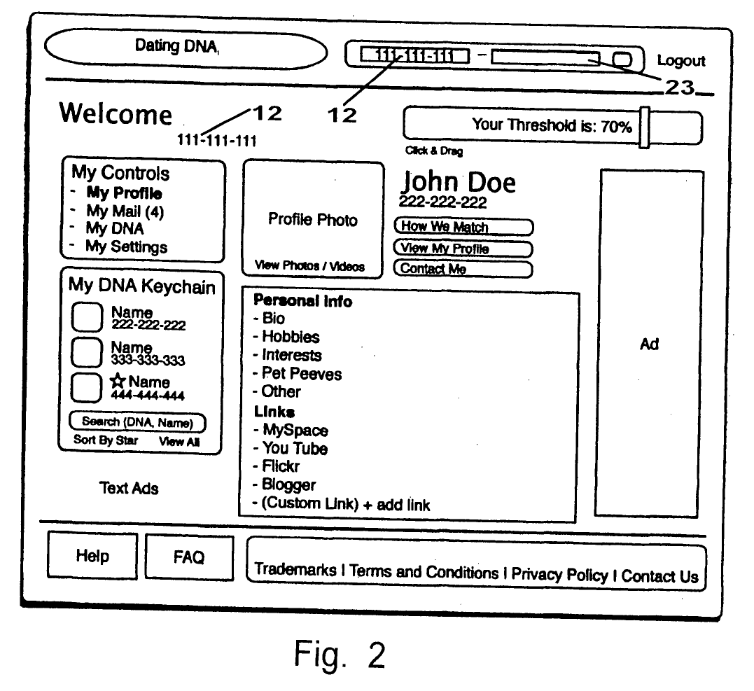

This input can be over a computer or a computer network such as the Internet. The input device may be a computer, a cell phone, a PDA, or any device capable of communicating the individual identifiers to the computer operating the software and receiving an answer therefrom. As shown in FIG. 2, the input may be done using a communicated profile page by placing the unique identifier 12 of the other user into a query box 23 to request a comparison with another unique identifier 12.

If both parties have their own individual identifiers relating to their respective compatibility profiles, the software adapted to the task, upon receiving both individual identifiers 12, will produce a compatibility score 18 which will in some manner provide an indication as to the compatibility level between the two individuals based on their compatibility profiles which were ascertained from both individuals taking the same compatibility survey. While this input and comparison to generate the match score 18 is best done on a computer adapted to the task and networked, as noted, it could be done by cellphone or other means to allow the software to compare the two identified persons respective compatibility profiles.

Once communicated to the users, this compatibility match score 18 generated can be employed to quickly determine their potential for compatibility in areas such as friendship, dating, groups or committee members, meeting, or even marriage between the two individuals. The compatibility score 18 may be employed by two newly introduced persons using a cellphone to input their respective individual identifiers, or by single user in a search of members of the service who have compatibility match scores 18 within an acceptable range of a threshold 17.

This employment of an assigned or chosen unique personal identifier 12, insures that persons may remain anonymous until they both decide that a sufficient chance at success is ascertainable from the compatibility score that is communicated to them. For many users, especially women who may be in a night club, the ability to remain anonymous and not hand out their phone number or address is particularly appreciated. Their safety is enhanced until they decide to allow personal information to be communicated to the inquiring party they meet. If the potential suitor has their own respective personal identifier 12 from the system, the comparison to find the match score 18 may be done immediately using a local computer communicating over a network with the computer housing the appropriate comparison software. In cases where only one person has the assigned or chosen unique identifier 12, the receiving party would be required to take the compatibility survey 15 and receive their own unique identifier 12 prior to any exchange of personal information 21 with the other person.

Allowance for this subsequent communication is optional. Both parties having the unique identifiers may input match criteria which will be employed by the software adapted to run the service for criteria required for an appropriate compatibility score match threshold 17. Consequently, allowing the users to set individual specific match criteria requirements for their mates requires that the compatibility score meet or exceed both such match criteria threshold 17 to allow for subsequent contact and communication of personal information 21.

By allowing both parties to set match criteria prior to personal information disclosure, the system provides great safety to one or both users who might meet in person at a bar or nightclub. One person or both must input the individual identifiers 12 of their own and the other person and allow the system to calculate a compatibility score 18 that meets or exceeds both parties preset compatibility score criteria threshold 17, before personal information is exchanged 21. Thus the system provides for anonymous personal identification between the subscriber and third parties, at bars, nightclubs, on airplanes, at parties, in chat rooms, or wherever two people might meet and communicate and determine a physical or mental attraction to the other. Where formerly such people might give away their phone number, they instead exchange their assigned or chosen unique personal identifier 12 as a means for future personal contact. Information to complete that contact would only be provided if the resulting compatibility meets or exceeds the preset minimums of both people.

Optionally, both parties may be informed of the failure of the other to meet the threshold compatibility score 17, and if both parties agree, the profile of personal contact information might still be exchanged. This might occur where the two parties were introduced by a mutual friend or at church or where the physical attraction was so strong that they both wish to override the Compatibility Threshold.

In an especially preferred mode of the method and system herein, communication with the remote computer running the software adapted to ascertain compatibility match scores 18 would be handled by cellular telephones. In this mode of operation of the method, a subscriber or user can initiate a real time compatibility test of themselves and another user or subscriber by entering their respective personal identifiers for communication to the remote computer. This communication of unique identifiers 12 of both persons may be text messaged, input using key tones, or otherwise input for receipt by a remote computer with the software for the purpose. Once the two identifiers were compared, the compatibility score 18 would be text messaged or orally sent, thereby revealing in real time the two persons potential for compatibility.

Another unique mode of operation of the system herein may be provided for subscribers or users to seek out potential matches for compatibility at a geographic point proximate to their own respective location. This would be provided using the modern cell phone triangulation or GPS location abilities of the phones themselves. Employing this mode of the method, subscribers or users would provide permission for the system to track their position on the earth during time segments based on the positions reported by their phones. A user seeking a potentially compatible date for the evening would input their unique identifier 12 and request the system to ascertain any other user with a unique identifier 12 in a close location. Additionally, software adapted to the task would ascertain if those subscribers or users whose cellular phones identify them as closely located have a sufficient compatibility match score 18 for both parties to be notified of the others contact information 21. If such a match occurs and both parties have elected to employ this mode of operation, the requesting user would be notified by text or audible messaging and the other party also notified. Thereafter either party can initiate contact with the other who has been identified as close at hand and compatible using their cell phones, or in person, if the other party is sufficiently local.

In another preferred embodiment of the system 10 herein a “drive-by” comparability is provided for internet visitors who are browsing the internet and intentionally or randomly visit a website or social networking site, which features another person on the site. Common examples of such featured persons would be individuals with profile pages on social networking sites such as MySpace, Facebook, Friendster, etc. However, featured persons could be featured in any number of ways on the Internet, such as personal web sites, blogs, personal ads on sites such as Craigslist, and so on. A featured person could be featured as simply as their name mentioned in a news story.

Unlike the previous mode of the system 10 where an actual meeting of the two parties occurs and information exchanged, in this mode of the system 10 no such initial meeting and exchange is necessary. The visitor in this mode of the system 10 would be browsing the Internet and happens upon a page having a featured person thereon. For example a featured person could have their profile posted on a social networking page such as MySpace and the visitor might happen across it intentionally or unintentionally. Or a featured person might post a personal ad online and the visitor finds the ad and reads it. Or a featured person might run a Blog and the visitor happens upon it. Or for instance a news story runs about a featured person being an eligible bachelor and a visitor reading the story finds the featured person's name.

In this mode of the system 10 to generate a compatibility match score 18 between the visitor and the feature person, the visitor to a website need only arrive at the featured persons' webpage and employing software in the visitor's browser and using a “widget” or API (Application Program Interface)which is placed on the webpage of the owner causes a display to the visitor of a compatibility match score 18 of the visitor with the featured person. The compatibility match score 18 is displayed to the visitor immediately upon arrival at the owner or featured person's site. In some cases, hosting sites for such webpages will only allow static information to be displayed to a visitor if at least one keystroke is input by the visitor. For these sites, the compatibility match score 18 is immediately displayed to the visitor after the mouse is clicked one time or some other input key depressed.

To achieve this instant compatibility matching between the visitor and a featured person who would be the owner of the webpage that is being frequented by the visitor, the owner must first get unique personal identifier 12 which is obtained in the same fashion as the other mode of the system. The owner of the website intending to host the API or “widget” would first log onto the website of the compatibility matching score provider.

As shown in FIG. 1 the owner of the website inputs identification and contact information and then submits to standardized compatibility testing 15 by the matching service providing it. Personality factors for the owner and other visitors taking the compatibility testing 15 are ascertained through the provision of an online multiple choice or other personality test in the testing using a survey or test page such as in FIG. 4.

In the same fashion as the embodiment of the system 10 requiring some form of communication between parties, the results of the survey or test are determined by their answers to the questions 13 presented. These answers are then compared against testing norms and other researched indicators for their individual specific personality facets based on the test. Again in the same fashion as the initial embodiment of the system, questions presented would seek to ascertain the owner's individual personality factors from answers to questions including but not limited to: the type of relationship in which they are interested, their age compatibility with others, their geographic compatibility, individual views, views in regards to children, current living situations, types of preferred physical attraction, ethnic backgrounds, smoking, drinking & drugs, views on romance & intimacy, personal temperament personality traits, sports & exercise, hobbies, interests, education, career, finances, politics and religion.

Once the test is completed, an individual compatibility profile or score 16 for the intended website owner and host of the API is ascertained based on the questions 15 answered in the survey. The owner or featured person of the intended webpage is then provided with a unique personal identifier 12 which may be a string of numbers, letters, or both, or a personal name, “handle”, or identifier, which is specific to that individual and directly related in the database to their individual compatibility profile and compatibility score 16. In the current preferred mode of the method, the unique personal identifier 12 is known as their individual Dating DNA ID.

At this point the system 10 differs in that the “widget” or API (Application Program Interface) is made available to the website owner and featured person, to be placed their webpages that feature them. This API is a small piece of computer code, program, or widget, which enables “Drive-by” Compatibility Scoring 18 to take place when Visitors arrive at and view the Owner's webpage containing the issued API.

In use when Visitors browse an Owner's page while surfing the Internet the issued API immediately communicates between the Owner's page and the issuing matching service which in this case is known as Dating DNA but could be known by any name. Based on the visitor's login status with the issuing matching service there are two possible outcomes.

In a first outcome, if the Visitor is not logged into an account from the issuing matching service because they do not have a personal identifier 12 from the matching service, or they do have a personal identifier 12 number but are not logged into the matching service it will cause the API to display the Owner's first name, the Owner's unique personal identifier 12 and the owner's Compatibility threshold 17 which was input by the owner during the survey and testing, and optionally the range of Compatibility Scores 18 between the Owner and other people.

Subsequent to this display of information, the Visitor is then directed to login to the matching service if they own a personal identifier 12, already, or to login to the matching service to submit to the input of identification information and testing to get a personal identifier 12, so that they may then view their Compatibility Match Score 18 with the Owner of the site they are visiting.

In a second possible outcome, if the Visitor already has a personal identifier 12 and is logged into their account at the issuing matching service, the API will communicate between the Owner's page and the Visitor's stored compatibility profile at the matching service and display the first name for both the Owner and Visitor, their respective personal identifiers 12, and the respective Compatibility Thresholds for both the Owner and Visitor, and/or the range of Compatibility Scores between the Owner and other people, and the Compatibility match Score 18 between the Owner and the Visitor. The compatibility match score 18 is displayed automatically by the API upon viewing the page, without any keyboard interaction unless required by the site hosting firm as noted. The visitor in this case knows instantly the degree of compatibility with the owner and featured person on the webpage containing the API.

After the compatibility match score 18 is revealed on the screen of the Visitor's computer, other options may then also be presented to the Visitor, such as adding the featured person or owner to the visitor's history file which is stored on the matching service computer or on the Visitor's computer. If the match score 18 is at or above the threshold required by the owner and visitor, contact information may also be emailed or otherwise forwarded to both parties, in a protected mode to at first protect the personal contact information of both but offering to initiate direct communication upon affirmation of both parties.

Using this mode of the system 10 herein described and disclosed, owners of websites and webpages which feature themselves can thus, without initial personal contact with a visitor to the website, inform those visitors' who possess a personal identifier 12 and comparability score 16 immediately of the potential compatibility with themselves.

The method and apparatus for providing unique identifiers to persons subsequent to compatibility profile testing allowing persons to remain anonymous to potential dates or friends prior to compatibility comparison shown in the drawings and described in detail herein, disclose steps in a process, arrangements of elements of particular construction, and configuration for illustrating preferred embodiments of structure and method of operation of the present invention. It is to be understood, however, that elements of different construction and configuration and different steps and process procedures and other arrangements thereof, other than those illustrated and described, may be employed for providing the method herein within the spirit of this invention.

As such, while the present invention has been described herein with reference to particular embodiments thereof, a latitude of modifications, various changes and substitutions are intended in the foregoing disclosure, and it will be appreciated that in some instance some features of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

What is claimed is:

1. A method of providing compatibility matching between humans using software operating on a computer which is accessible through connection devices, comprising the steps of:
providing a network access to an individual hosting a website to login to a compatibility matching service;
having said individual input information identifying said individual and information on contacting said individual and forming their contact information in an electronic personal profile containing at least a means to contact said individual;
storing said personal profile in a memory accessible by said software;
administering a survey to said individual, to ascertain a compatibility score based on answers to said survey by said individual compared against testing norms and other researched indicators for personality facets;
assigning said compatibility score to said individual;
storing said compatibility score in an association with said personal profile of said individual assigned said compatibility score;
assigning each said individual a unique personal identifier relating to their respective personal profile;
creating an Application Program Interface (API) for said individual which causes one or a plurality of actions to occur on the computer of a visitor to said website of said individual, and transmitting said API to said individual for inclusion into the code of said website of said individual;
said API initiating a first set of actions should said API ascertain said visitor has a their own respective personal identifier from said compatibility matching service and is concurrently logged into said matching service, including:
said API communicating with said compatibility matching service and ascertaining a compatibility score for said visitor based on said personal identifier of said individual and a said compatibility score for said individual on file with said matching service;
causing a display of the first names of both said individual and said visitor on said visitor's computer display;
causing a display of the respective personal identifiers of both said visitor and said individual on said visitor's computer display;
causing a display of a compatibility match score on said visitor's computer display, based on said individual's compatibility score and said visitor's compatibility;
said API initiating a second set of actions should said API ascertain said visitor does not possess their own respective personal identifier from said compatibility matching service or is not concurrently logged into said matching service, including:
said set of actions including:
causing a display of the first name of said individual on said visitor's computer display;
causing a display of said personal identifier assigned to said individual by said matching service on said visitor's computer display;
causing a display on said visitor's computer display of said compatibility threshold chosen by said individual and stored by said matching service;
communicating instructions said visitor to go the website of said matching service to login if they have a said unique identifier or to submit to said survey and provide requested information required to obtain a said unique identifier and a said compatibility score for said visitor; and
communicating to said visitor that should said instructions be followed, that a said compatibility match score between said visitor and said individual will be provided subsequently; and
causing a compatibility match score to be displayed on said visitor's computer display should said API determine said instructions have been followed.

2. The method of providing compatibility matching between humans of claim 1 including the additional steps of:
providing respective said contact information to both said visitor and said individual should said compatibility match score therebetween meet or exceed a respective threshold score set by both said individual and said visitor.
